(19) United States
(12) Patent Application Publication
(10) Pub. No.: US 2011/0131498 A1
(43) Pub. Date: Jun. 2, 2011

(54) PRESENTATION METHOD AND PRESENTATION SYSTEM USING IDENTIFICATION LABEL

(75) Inventors: Kuo-Chuan Chao, Taipei (TW); Shyh-Feng Lin, Taipei (TW); Kun-Chou Chen, Taipei (TW)

(73) Assignee: AVERMEDIA INFORMATION, INC., Taipei (TW)

(21) Appl. No.: 12/957,652

(22) Filed: Dec. 1, 2010

(30) Foreign Application Priority Data
Dec. 2, 2009 (TW) 098141234

(51) Int. Cl. G06F 3/00

(52) U.S. Cl. 715/723

(57) ABSTRACT

A presentation system includes a video supply device and a video receiver device. A presentation method is used with the presentation system and a network. The video supply device provides an image including an identification label corresponding to the video receiver device. At first, the video receiver device issues a sensing signal in response to a user's operating action on the video receiver device. After the video supply device receives the sensing signal through the network, the identification label in the image is displayed in a dynamic manner.

### FIELD OF THE INVENTION

The present invention relates to a presentation method using identification labels, and more particularly to a presentation method for showing images with dynamic identification labels. The present invention also relates to a presentation system.

### BACKGROUND OF THE INVENTION

Recently, a videoconferencing technique is gradually developed to enable individual users in faraway sites to have meetings or communicate with each other. That is, through a video conference, the users at different cities or countries could discuss with each other in real time. In other words, the meeting can be held in a real-time and efficient manner according to the videoconferencing technique.

Hereinafter, a process of making a video conference will be illustrated. First of all, a videoconferencing system is initiated by a chairman. Then, the participants at different cities are in communication with the videoconferencing system. During the video conference, if a speaker wants to show documents to others, the image of the presentation documents and the live video of the conference site should be transmitted according to specified transmission protocols or standards. For example, ITU-T H.239 is a standard for transmitting presentation contents, and H.264 is a standard for transmitting live video of the conference site.

The conventional process of making the video conference, however, still has some drawbacks. For example, since the presentation document images are provided by the control end during the video conference, if any participant has opinions about the presentation contents, the participant has to describe the position of the description or the drawing to be discussed in advance, for example “In page 3, FIG. 3, line 1” or “Page 2, line 2”. Thus, other participants can realize the content position under discussion. It affects the smooth of the meeting.

In addition, this videoconferencing technique involves one-way communication rather than interactive communication. That is, the participants at different sites are in communication with the chairman or the presentation reporter, but it is in convenient for the participants at different sites to communicate with each other. That is, horizontal communication between the participants at different sites to indicate or interpret the presentation contents is not fully achieved, but the presentation contents are passively received by the participants in a broadcasting-like manner.

From the above description, it is found that the conventional videoconferencing technique is poorly interactive. The conventional videoconferencing technique becomes hindrance for the participants from discussing the presentation contents with each other.

For obviating the drawbacks encountered from the prior art, there is a need of providing a method to enhance the interactive efficacy of the video conference and increase the efficiency of making the video conference.

### SUMMARY OF THE INVENTION

In accordance with an aspect of the present invention, there is provided a presentation method for use between a video supply device and a video receiver device through a network. The video supply device provides an image including an identification label corresponding to the video receiver device. At first, the video receiver device issues a sensing signal in response to a user's operating action on the video receiver device. Then, the sensing signal is transmitted to the video supply device through the network. When the video supply device receives the sensing signal, the identification label in the image is displayed in a dynamic manner.

In an embodiment, the identification label includes a video object, an audio object or a text object. The video object may be represented by a picture, a color or an icon. The icon may be a company logo, a trademark, a department code, a totem or a flag icon.

In an embodiment, the user's operating action includes making sounds or moving a pointing device.

In an embodiment, the dynamic manner includes flickering, color-inverting, highlighting, or other noticeable manner.

In accordance with another aspect of the present invention, there is provided a presentation system for use with a network during a video conference. The presentation system includes a video receiver device and a video supply device, both of which are in communication with the network. The video receiver device issues a sensing signal in response to a user's operating action on the video receiver device. The video supply device provides an image including an identification label corresponding to the video receiver device. When the sensing signal is received by the video supply device through the network, the identification label is controlled to be displayed in a dynamic manner.

In accordance with a further aspect of the present invention, there is provided a presentation system for use with a network during a video conference. The presentation system includes a video receiver device, a video supply device and a video management device, each of which is in communication with the network. The video receiver issues a first sensing signal in response to a first user's operating action, and the video supply device issues a second sensing signal in response to a second user's operating action. The video management device provides an image to the video receiver device and the video supply device. The image includes a first identification label and a second identification label corresponding to the video receiver device and the video supply device, respectively. The first identification label is displayed in a dynamic manner in response to the first sensing signal, and the second identification label is displayed in a dynamic manner in response to the second sensing signal.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating the communication in a videoconferencing system based on the H.323 protocol;

FIG. 2A is a schematic functional block diagram illustrating a presentation system according to an embodiment of the present invention;

FIG. 2B is a schematic diagram illustrating the combination of a presentation document image and identification labels provided by the video supply device of FIG. 2A;

FIG. 3A is a schematic diagram illustrating an exemplary combined image that is displayed during a video conference according to the present invention;

FIG. 3B is a schematic diagram illustrating another exemplary combined image displayed that is displayed during a video conference according to the present invention;

FIG. 4A is a flowchart illustrating a data transmission process implemented by the video supply device;

FIG. 4B is a flowchart illustrating a process for providing the combined image by the video supply device;

FIG. 4C is a flowchart illustrating a data transmission process implemented by the video receiver device;

FIG. 5A is a schematic functional block diagram illustrating the video supply device of the presentation system according to an embodiment of the present invention; and

FIG. 5B is a schematic functional block diagram illustrating the video receiver device of the presentation system according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As previously described, the conventional videoconferencing technique is poorly interactive because the participants other than the presentation reporter fail to actively participate in the video conference. The present invention provides a method for the video conference in order to indicate the identities of the participants. According to the present invention, by displaying the identification labels corresponding to respective conference devices in a dynamic manner, the participants other than the presentation reporter can participate in the video conference in a more active manner.

For most video conferences, the H.323 protocol provides a foundation for real-time video and data communications over packet-based networks. As known, the H.323 protocol also includes some sub-protocols to provide supplementary services supporting or delivering other functionality to the user. Some of these sub-protocols are for example H.264, H.245, H.239 and H.460.

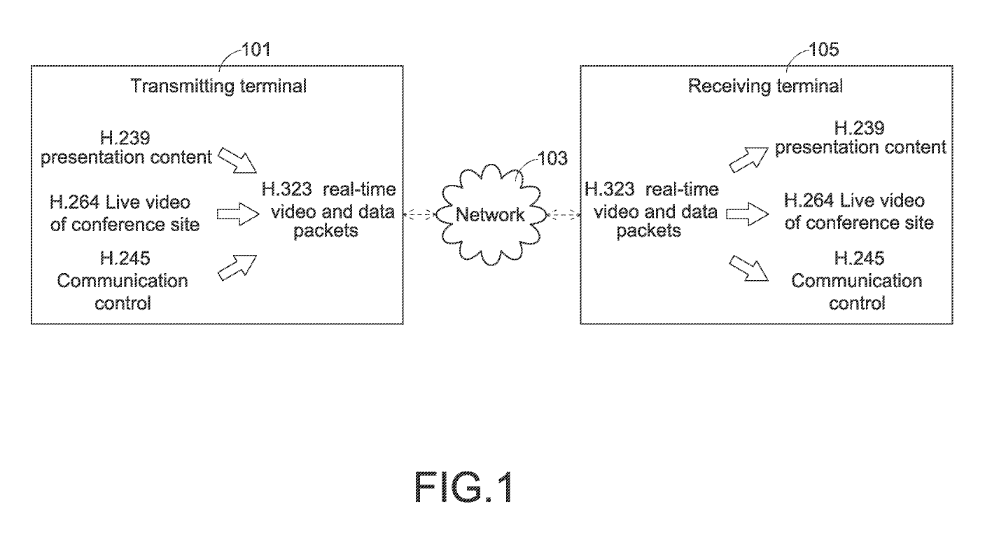

FIG. 1 is a schematic functional block diagram illustrating the communication in a videoconferencing system based on the H.323 protocol. During a video conference, the data in the H.239, H.264 and H.245 formats are firstly packed into H.323 real-time video and data packets by the transmitting terminal 101. Then, the H.323 packets are transmitted to a receiving terminal 105 through a network 103. After the H.323 packets are received by the receiving terminal 105, the H.323 packets are unpacked and restored into the original data in the H.239, H.264 and H.245 formats.

Although the H.323 protocol includes various sub-protocols, in views of clarification or brevity, only some sub-protocols related to the concepts of the present invention are shown in FIG. 1. For example, H.239 is a standard for transmitting presentation contents, H.264 is a standard for transmitting live video, and H.245 is a standard for communication control. In addition, H.245 also provides user-defined functions. Hence, the present invention takes advantage of the user-defined functions of the H.245 protocol to establish communication between conference devices. The method for defining the identification labels corresponding to respective conference devices during the video conference will be illustrated later.

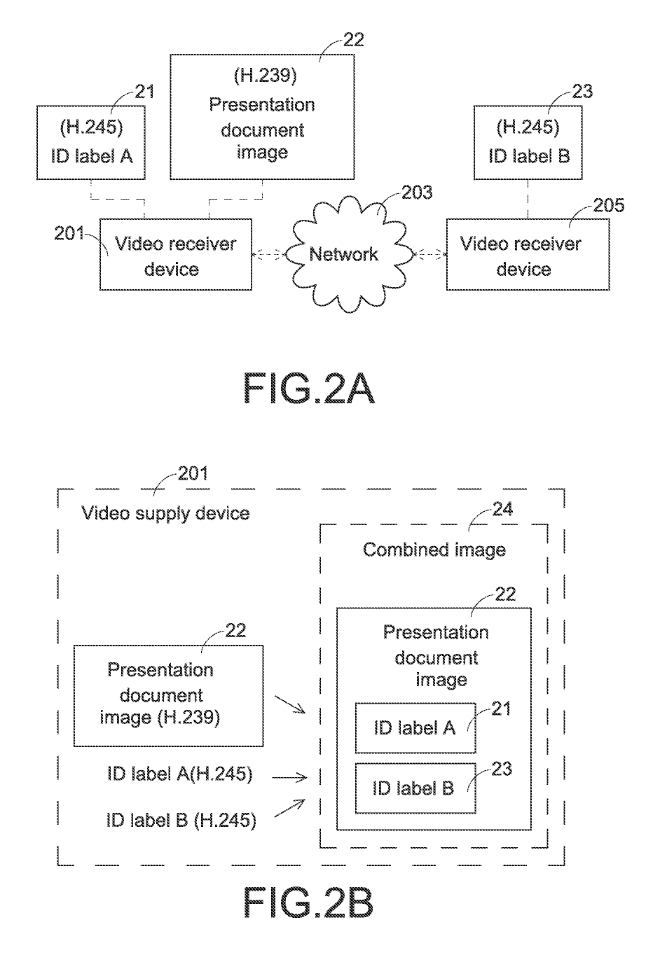

FIG. 2A is a schematic functional block diagram illustrating a presentation system according to an embodiment of the present invention. Through a network 203, a videoconferencing system including a plurality of conference devices is established. The conference devices may be functioned as a video supply device 201 or a video receiver device 205 according to the role in the video conference. The user of the video supply device 201 is for example a conference sponsor or a reporter that is making a presentation in the video conference. The user(s) of the video receiver device 205 includes any participant of the video conference. For example, the user(s) of the video receiver device 205 includes a single participant at a different site or a plurality of participants at several different sites.

Hereinafter, the operations of the presentation system will be illustrated with reference to FIG. 2A. First of all, a presentation document image 22 in the H.239 format is transmitted from the video supply device 201 to the video receiver device 205 through the network 203. In addition, an identification label 21 (ID label A) corresponding to the video supply device 201 and an identification label 23 (ID label B) corresponding to the video receiver device 205 are attached to the presentation document image 22. According to the user's operating actions on the video supply device 201 and/or the video receiver device 205, the identification labels of corresponding conference devices are displayed in a dynamic manner.

In accordance with the present invention, the user-defined functions associated with communication control based on the H.245 protocol are utilized. Specifically, the identification labels corresponding to respective conference devices (e.g. the video supply device 201 and the video receiver device 205) during the video conference should be defined in advance. As a consequence, when the presentation document image 22 is displayed on the conference devices, the identification labels could be superimposed on the presentation document 22 according to an on-screen display (OSD) technology.

Please refer to FIG. 2A again. The presentation method of the present invention is applied to the presentation system including the video supply device 201 and the video receiver device 205, which are in communication with each other through the network 203. The network 203 is a homogeneous network or a heterogeneous network. The identification label 21 (ID label A) corresponding to the video supply device 201 and the identification label 23 (ID label B) corresponding to the video receiver device 205 are transmitted according to the H.245 protocol with the user-defined feature.

The presentation method will be illustrated as follows. First of all, images provided by the video supply device 201 are transmitted to the video receiver device 205 through the network 203. In response to a user's operating action on the video receiver device 205, the video receiver device 205 issues a first sensing signal. When the first sensing signal is received by the video supply device 201 through the network 203, the identification label 23 (ID label B) is displayed on the display in a dynamic manner so as to indicate the operating status of the video receiver device 205.

Similarly, in response to a user's operating action on the video supply device 201, the video supply device 201 issues a second sensing signal. According to the second sensing signal, the identification label 21 (ID label A) corresponding to the video supply device 201 is displayed on the display in a dynamic manner to show the operating status of the video supply device 201 to other participants.

FIG. 2B is a schematic diagram illustrating the combination of a presentation document image and the identification labels provided by the video supply device of FIG. 2A. The video supply device 201 combines the presentation document image 22, the identification label 21 (ID label A) and the identification label 23 (ID label B) and generates the combined image 24. In a similar manner, a plurality of sensing signals issued from a plurality of video receiver devices 205 are received by the video supply device 201 through the network 203, and the identification labels corresponding to respective video receiver devices 205 are allocated by the video supply device 201. Then, the identification labels are superimposed on the presentation document image 22 according to the OSD technology. As a consequence, the combined image 24 is generated. In an embodiment, the identification labels of the conference devices are predetermined pictures designated by respective conference devices or available pictures allocated to the respective conference devices by the video supply device 201.

In an embodiment, the combined image 24 is directly provided by the video supply device 201. Alternatively, the combined image 24 is provided by an additional video management device (not shown). The video management device may also have the function of coordinating and managing the resource during the video conference. For enhancing the transmission speed of the video data through the network 203 (e.g. a homogeneous network or a heterogeneous network) during the video conference, the transmitted images may be optionally converted, compressed or encrypted to reduce the dataflow.

For understanding the feature and object of the present invention, an exemplary combined image will be illustrated as follows.

For example, a video conference is established to allow three participants c, d and e at three branch companies C, D and E of a company F to interact with each other. The topic subject of the video conference involves the business conditions of these three branch companies C, D and E. It is assumed that the participant c at the site C is the conference sponsor or the reporter that is making a presentation.

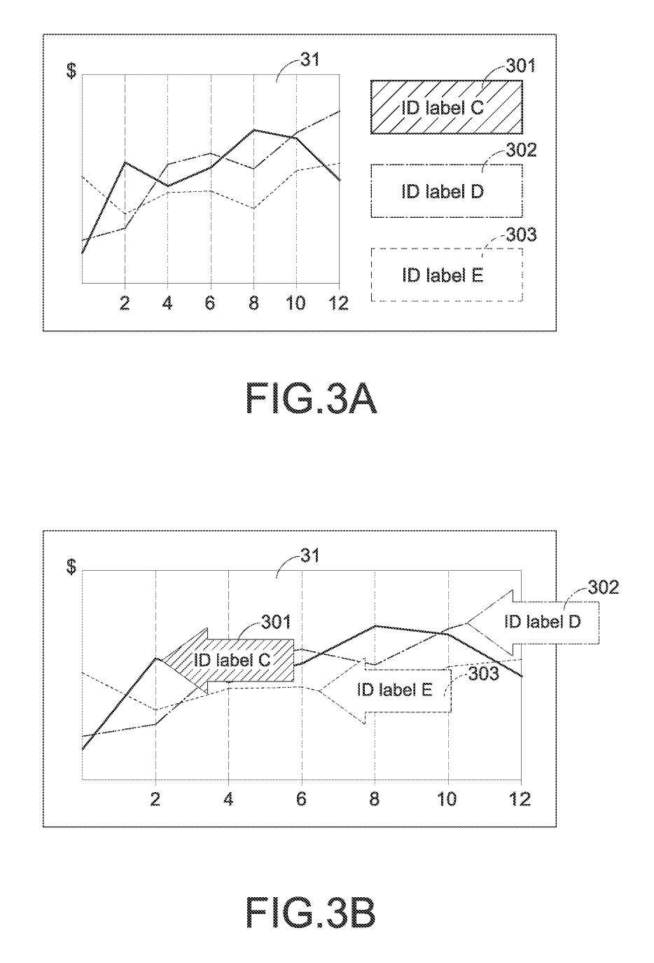

FIG. 3A is a schematic diagram illustrating an exemplary combined image that is displayed during a video conference according to the present invention. The line chart 31 shown in FIG. 3A indicates the annual marketing business amounts of these three branch companies C, D and E. In addition, three legend-type identification labels 301, 302 and 303 are shown on the right side of the line chart 31. In an embodiment, the identification labels 301, 302 and 303 are represented by the images of the participants c, d and e, respectively. Alternatively, the identification labels 301, 302 and 303 can be represented by the symbols of respective regions/countries where the three branch companies C, D and E are located. For example, in a case that the three branch companies C, D and E are located at different countries, the identification labels 301, 302 and 303 are represented by flags of respective countries. Whereas, in a case that the three branch companies C, D and E are located at different cities, the identification labels 301, 302 and 303 are represented by respective city names.

In addition to the legend-type identification labels, other types of identification labels may be adopted to indicate the participants. For example, a plurality of cursor-type identification labels are shown on the line chart 31 to indicate respective conference devices in FIG. 3B. Alternatively, the identification labels corresponding to respective conference devices may be represented by specified colors.

Moreover, during the video conference, any conference device (e.g. the participant c) may use a pointing device (e.g. a remote controller or a mouse) to point and click the combined image on the display. While the participant c is using the pointing device or making sounds (e.g. providing an oral explanation), the legend-type identification label corresponding to the participant c may be displayed in a more attractive manner such as flickering, color-inverting or highlighting (see FIG. 3A). In some embodiments, while the remote controller is moved by the participant c, the cursor corresponding to the participant c is changed into a specified color (e.g. blue color). Moreover, the cursor-type identification labels may be directly shown on the line chart (see FIG. 3B). The cursor-type identification labels may include dynamic or static images or icons/names of the regions/countries of the participants and show who is using the pointing device or reporting. In other words, according to the dynamic identification label, all of the participants can realize the participant c is the one who is explaining the line chart 31. In addition, according to the movement of the cursor c, other participants may easily realize the reporting spirit.

In some embodiments, in a case that one of the participants is reporting or explaining the presentation contents (e.g. the business conditions of the three branch companies), the associated line in the line chart 31 may become noticeable so as to be distinguished from other lines. Moreover, by executing specified software, the users may determine and set the display patterns (e.g. cursors, dialog boxes, highlighting objects or combinations thereof) to emphasize the associated information. For example, a cursor-type identification label and a dialog box may be simultaneously used to represent the same participant. Alternatively, the types of identification labels corresponding to different participants may be different from each other.

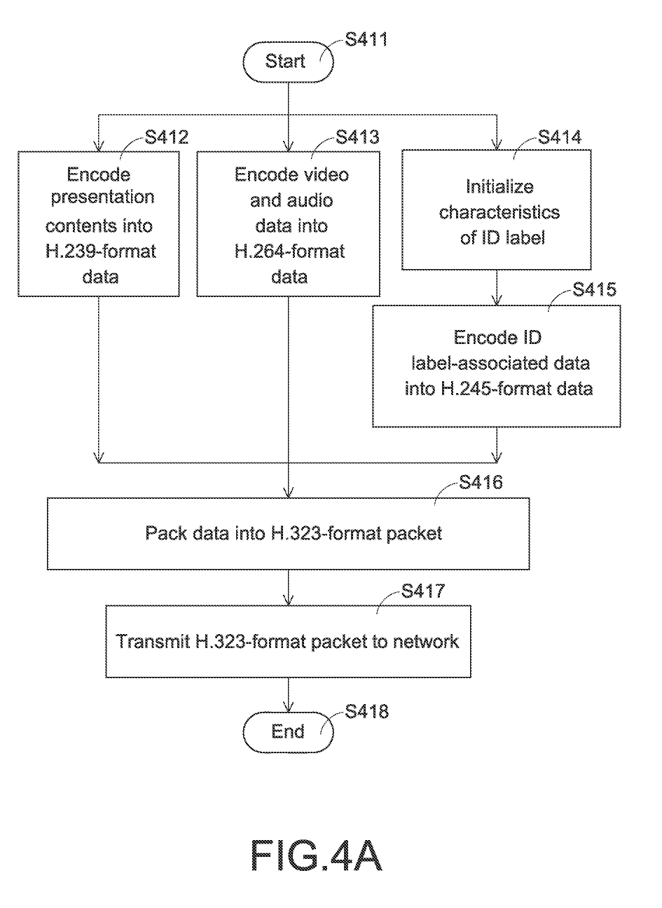

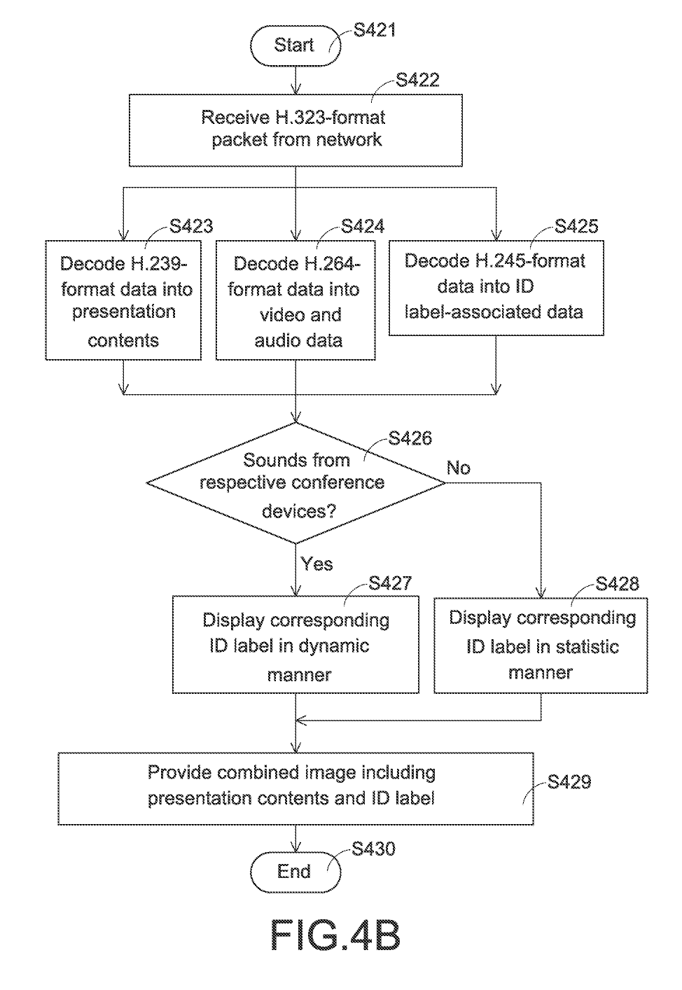

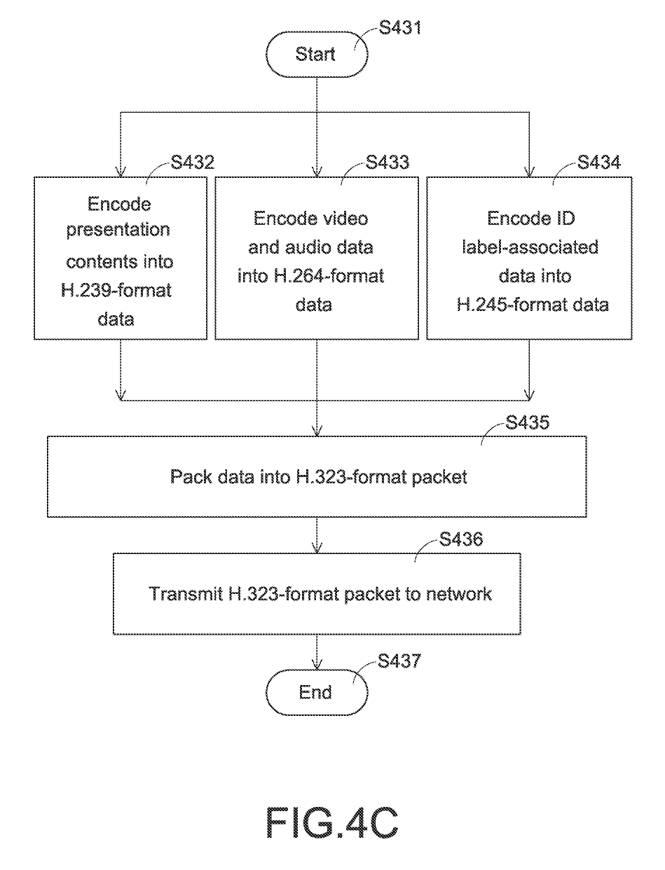

FIG. 4A is a flowchart illustrating a data transmission process implemented by the video supply device 201. After the data transmission process starts (Step S411), various data are processed into proper formats according to the types of the data. For example, the presentation contents are encoded into H.239-format data (Step S412), and the video and audio data are encoded according to a video compression format such as the H.264 format (Step S413). In addition, the color, shape and other characteristics of the identification label and the image and the position of the identification label are initiated (Step S414). Then, the identification label-associated data (including color, shape and position) are encoded into H.245-format data (Step 415).

After the H.239, H.264 and H.245-format data are obtained, these data are packed into a H.323-format packet (Step S416), and then the H.323-format packet is transmitted to the network 203 (Step S417). Meanwhile, the data transmission process implemented by the video supply device 201 ends (Step S418).

FIG. 4B is a flowchart illustrating a process for providing the combined image by the video supply device 201. After the process starts (Step S421), a H.323-format packet is received by the video supply device 201 (Step S422). According to the practical applications, the H.323-format packet is unpacked, and then decoded into corresponding data according to the H.239, H.264 and H.245 standards (Steps S423, 424 and 425). Moreover, if any of the conference devices transmits audio signals to the video supply device 201, i.e. the user is talking (Step S426), the video supply device 201 realizes which conference device is “active”. Thus, the identification label corresponding to the specified conference device is displayed in a noticeable or dynamic manner (e.g. a flickering manner) (Step S427). Whereas, the identification labels corresponding to the “inactive” conference devices (i.e. the user is not talking) are displayed in an unselected or statistic manner (Step S428). Furthermore, the identification label may be moved to a position near the associated data corresponding to respective conference devices. Then, the combined image including the presentation contents and the identification labels is transmitted to all the conference devices for display (Step S429), and the data process for providing the combined image 24 is finished (Step S430).

FIG. 4C is a flowchart illustrating a data transmission process implemented by the video receiver device 205. As previously described, during the video conference, the conventional video receiver device only transmits the live video of the conference site and passively receives the presentation contents. The data transmission process implemented by the video receiver device 205 of the present invention is distinguishable. After the data transmission process starts (Step S431), the video and audio data are encoded into the H.264-format data (Step S433). If the presentation contents are provided by the video receiver device 205, but not the video supply device 201, the video receiver device 205 also encodes the presentation contents into H.239-format data (Step S432). Under this condition, step S412 in FIG. 4A may be eliminated. In other words, it is possible that the presentation contents and the combined image are provided by different conference devices.

Moreover, in response to the user's operating action on the video receiver device 205, the identification label-associated data will be obtained and encoded into H.245-format data (Step S434). The user's operating action may include moving a pointing device such as a remote controller or making sounds (reporting or talking). For example, if the pointing device is moved by the user, the moving tracks of the pointing device are recorded and may be included in the identification label-associated data. If it is detected that the user is talking, the video receiver device 205 issues a sensing signal to inform the video supply device 201. After the H.264 and H.245 (or H.239)-format data are obtained, these data are packed into a H.323-format packet (Step S435), and then the H.323-format packet is transmitted to the network 203 (Step S436). Meanwhile, the data transmission process implemented by the video receiver device 205 is finished (Step S437).

In accordance with the present invention, the identification labels corresponding to the video supply device 201 and the video receiver device 205 may include video objects, audio objects, text objects or the combinations. Once the sensing signal from the video receiver device 205 is received through the network 203, the identification label corresponding to the video receiver device 205 is displayed in a noticeable or dynamic manner such as flickering, color-inverting or highlighting. Similarly, once the video supply device 201 issues a sensing signal in response to the user's operating action, the identification label corresponding to the video supply device 201 is also displayed in the similar manner.

Moreover, the identification labels corresponding to the video supply device 201 and the video receiver device 205 may be represented by images, colors or icons. The icons are diversified. An example of the icon includes but is not limited to a company logo, a trademark, a department code, a totem or a flag icon. In a case that the identification labels are represented by images, the identification label corresponding to the participant who is talking is a real-time dynamic image, but the identification labels corresponding to the other participants are still images.

In the presentation system, the video supply device 201 and the video receiver device 205 are in communication with each other to make a video conference and have corresponding identification labels. In addition, via a video management device in communication with the network, the live video provided by the video supply device 201 may be transmitted to the video receiver device 205. The video management device may have the functions of sensing the user's operating actions on the video supply device 201 and the video receiver device 205. Once a user's operating action on a specified conference device is sensed, the identification label corresponding to the specified conference device is displayed in a dynamic manner.

For achieving the above functions, the presentation document image (contents) provided by the reporter should be transmitted from the video supply device 201 to the video receiver devices 205 through the network 203. These video receiver devices 205 correspond to different identification labels. The method of combining the identification labels with the presentation document image and transmitting the combined image to the video receiver devices 205 may be varied according to the system resource. For example, after the identification labels and the presentation document image are combined by the video supply device 201, the combined image may be converted into digital data, which are then transmitted to the network 203. Alternatively, when the cursor on the screen of a specified conference device is moved, the data (e.g. the coordinates or moving tracks of the cursor) associated with the cursor-type identification label may be sent back to the video supply device 201, and then the data are transmitted from the video supply device 201 to all of the video receiver devices 205 through the network 203.

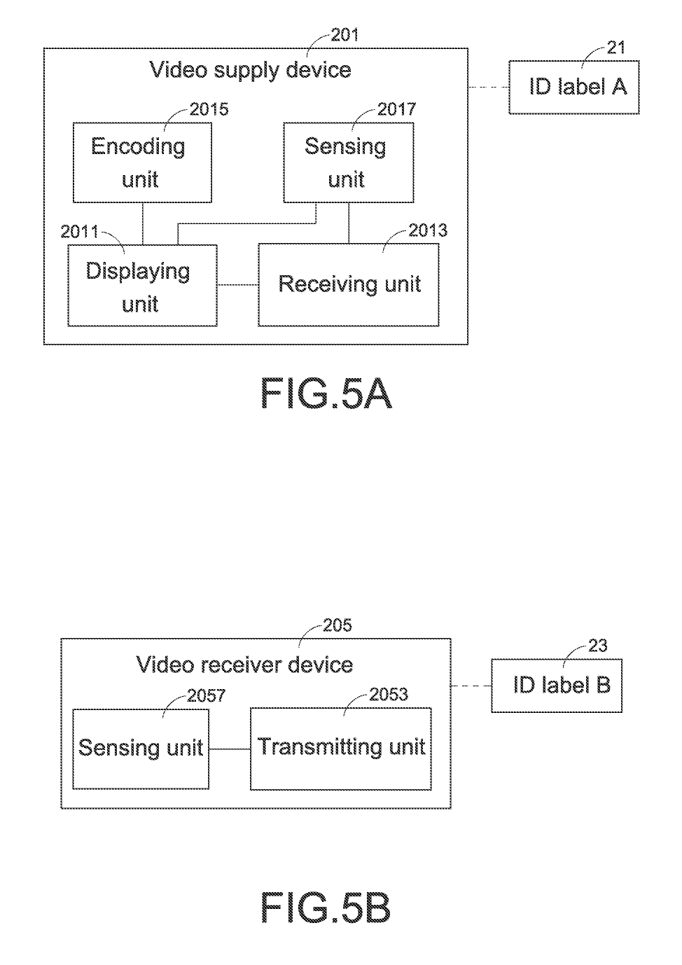

FIG. 5A is a schematic functional block diagram illustrating the video supply device of the presentation system according to an embodiment of the present invention. The video supply device 201 corresponding to the identification label 21 (ID label A) is in communication with the video receiver device 205 corresponding to the identification label 23 (ID label B) through the network 203. In response to a user's operating action on the video receiver device 205, the video receiver device 205 issues a first sensing signal to the network 203.

As shown in FIG. 5A, the video supply device 201 includes a displaying unit 2011 and a receiving unit 2013. The displaying unit 2011 is used for displaying the combined image including the presentation contents and the identification labels. The receiving unit 2013 is electrically connected to the displaying unit 2011 for receiving the sensing signal from the video receiver device 205 through the network 203. After the sensing signal is received, the identification label 23 (ID label B) corresponding to the video receiver device 205 is displayed on the displaying unit 2011 in a dynamic manner. Moreover, the identification label 23 (ID label B) may be superimposed on the presentation contents.

According to the present invention, the user's operating action includes, for example, moving a pointing device or making sounds. In response to the sounds, a sensing signal is generated. Whereas, in response to the movement of the pointing device, the moving tracks are recorded. After the sensing signal issued from the video receiver device 205 is received by the video supply device 201 through the network 203, the identification label 23 (ID label B) corresponding to the video receiver device 205 may be displayed on the displaying unit 2011 of the video supply device 201 in a dynamic or noticeable manner such as flickering, color-inverting or highlighting.

The receiving unit 2013 of the video supply device 201 receives the first sensing signal from the video receiver device 205 to perceive the user's operating action on the video receiver device 205. In addition, the video supply device 201 further include a sensing unit 2017 for sensing the user's operating action on the video supply device 201. The sensing unit 2017 is electrically connected to the displaying unit 2011 and the receiving unit 2013. In response to the sounds of the user or the movement of the pointing device, the sensing unit 2017 issues a second sensing signal, so that the identification label 21 (ID label A) corresponding to the video supply device 201 is displayed in a dynamic or noticeable manner. Similarly, the user's operating actions includes, for example, moving a pointing device or speaking.

Please refer to FIG. 5A again. The video supply device 201 further includes an encoding unit 2015 electrically connected to the displaying unit 2011. By the encoding unit 2015, the presentation document image or the combined image may be subjected to conversion, compression or encryption. In practice, the identification labels are superimposed on the presentation document image according to the OSD technology to provide the combined image. When the cursor shown on the display of the video supply device 201 or the video receiver device 205 is moved, the data (e.g. the coordinates or moving tracks of the cursor) will be transmitted to the video supply device 201, and then transmitted from the video supply device 201 to all of the video receiver devices 205 through the network 203.

FIG. 5B is a schematic functional block diagram illustrating the video receiver device of the presentation system according to an embodiment of the present invention. The video receiver device 205 corresponds to the second identification label 23 (ID label B). The video receiver device 205 is in communication with the video supply device 201 through the network 203 and receiving the presentation document image or the combined image provided by the video supply device 201.

As shown in FIG. 5B, the video receiver device 205 includes a sensing unit 2057 and a transmitting unit 2053. The sensing unit 2057 is used for detecting the user's operating action on the video receiver device 205, thereby issuing the first sensing signal. The sensing unit 2057 is electrically connected to the transmitting unit 2053. The first sensing signal is transmitted to the video supply device 201 through the transmitting unit 2053. After the first sensing signal is received by the video supply device 201, the identification label 23 (ID label B) may be displayed in a noticeable or dynamic manner such as flickering, color-inverting or highlighting. Afterwards, the video supply device 201 provides the combined image to all conference devices through the network 203.

The sensing unit 2057 of the video receiver device 205 may be designed according to the practical requirement of the videoconferencing system. For example, for detecting the sounds of the user of the video receiver device 205, the sensing unit 2057 includes an audio sensing module. Whereas, for detecting the movement of the pointing device, the sensing unit 2057 includes a position recording module for recording the moving data of the pointing device. Alternatively, the sensing unit 2057 includes an audio sensing module and a position recording module for respectively sensing the sounds and the position or moving track of the pointing device. The components of the sensing unit 2057 may be altered according to the practical requirements.

The sensing unit 2057 senses the user's operating action, and issues a corresponding sensing signal to the network 203 and the video supply device 201 through the transmitting unit 2053. As such, during the video conference, the video supply device 201 can realize which of the video receiver devices 205 is responding to the presentation, so that the identification label corresponding to this video receiver device 205 is displayed in a dynamic or noticeable manner.

In the presentation system, each of the conference devices can be selectively acted as the video supply device 201 or the video receiver device 205 during the video conference. That is, a conference device may be acted as the video supply device providing the presentation in the beginning, and then acted as the video receiver device later. In other words, the role of the conference device is switched from the video supply device to the video receiver device in order to receive the presentation data from the next reporter. For example, in the above embodiment, after the presentation is completed by the participant c, the conference device operated by the next reporter d is acted as the video supply device. Hence, each conference device may include both the receiving unit and the transmitting unit, or an integrated transceiver unit.

In the above embodiment, the presentation method and system illustrated complies with the H.323 protocol. It is noted that the protocol of the presentation method and system of the present invention are not restricted to the H.323 protocol. According to the present invention, the identification labels corresponding to respective conference devices are displayed in different manners according to the operating statuses of the conference devices. Through the identification labels, the participants of the video conference can realize who is reporting or providing oral explanation. As a consequence, the interactive efficacy of the video conference is enhanced to increase interactivity in the video conference.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A presentation method for use between a video supply device and a video receiver device through a network, the video supply device providing an image including a first identification label corresponding to the video receiver device, the presentation method comprising steps of:
issuing a first sensing signal by the video receiver device in response to a first user's operating action on the video receiver device;
receiving the first sensing signal by the video supply device through the network; and
displaying the first identification label in a dynamic manner in the image by the video supply device in response to the first sensing signal.

2. The presentation method according to claim 1 wherein the image is obtained by converting, compressing or encrypting a presentation document image.

3. The presentation method according to claim 1 wherein the first identification label includes a video object, an audio object or a text object, wherein the video object is represented by a picture, a color or an icon, and the icon is a company logo, a trademark, a department code, a totem or a flag icon.

4. The presentation method according to claim 1 wherein the first user's operating action on the video receiver device includes making sounds or moving a pointing device, and if the pointing device is moved, a moving track of the pointing device is recorded.

5. The presentation method according to claim 1 wherein the dynamic manner includes flickering, color-inverting, highlighting, or a combination thereof.

6. The presentation method according to claim 1, further comprising steps of:
issuing a second sensing signal by the video supply device in response to a second user's operating action on the video supply device; and
displaying a second identification label corresponding to the video supply device in a dynamic manner in the image by the video supply device in response to the second sensing signal.

7. The presentation method according to claim 6 wherein the second user's operating action on the video supply device includes making sounds or moving a pointing device, and if the pointing device is moved, a moving track of the pointing device is recorded.

8. The presentation method according to claim 6 wherein the second identification label includes a video object, an audio object or a text object.

9. A presentation system for use with a network during a video conference, the presentation system comprising:
a video receiver device in communication with the network, issuing a first sensing signal in response to a first user's operating action on the video receiver device; and
a video supply device in communication with the network, for providing an image including a first identification label corresponding to the video receiver device, and displaying the first identification label in a dynamic manner in the image.

10. The presentation system according to claim 9 wherein the image is obtained by converting, compressing or encrypting a presentation document image.

11. The presentation system according to claim 9 wherein the first identification label includes a video object, an audio object or a text object, wherein the video object is represented by a picture, a color or an icon.

12. The presentation system according to claim 9 wherein the first user's operating action on the video receiver device includes making sounds or moving a pointing device, and if the pointing device is moved, a moving track of the pointing device is recorded.

13. The presentation system according to claim 9 wherein the video supply device displays a second identification label corresponding to the video supply device in response to a second user's operating action on the video supply device.

14. The presentation system according to claim 13 wherein the second identification label includes a video object, an audio object or a text object, wherein the video object is represented by a picture, a color or an icon.

15. The presentation system according to claim 13 wherein the video receiver device comprises:
a first sensing unit for sensing the first user's operating action on the video receiver device, thereby issuing the first sensing signal; and
a transmitting unit electrically connected to the first sensing unit for transmitting the first sensing signal to the video supply device through the network.

16. The presentation system according to claim 13 wherein the video supply device comprises:
a displaying unit for displaying the image including the first identification label and the second identification label;
a first receiving unit electrically connected to the displaying unit for receiving the first sensing signal through the network;
an encoding unit, electrically connected to the displaying unit for converting, compressing or encrypting a presentation document image to be combined with the first identification label and the second identification label; and
a second sensing unit electrically connected to the displaying unit and the receiving unit for sensing the second user's operating action on the video supply device, thereby issuing a second sensing signal.

17. A presentation system for use with a network during a video conference, the presentation system comprising:
a video receiver device in communication with the network, issuing a first sensing signal in response to a first user's operating action on the video receiver device;
a video supply device in communication with the network, issuing a second sensing signal in response to a second user's operating action on the video supply device; and
a video management device in communication with the network, providing an image to the video receiver device and the video supply device, the image including a first identification label corresponding to the video receiver device and a second identification label corresponding to the video supply device wherein the first identification label or the second identification label is displayed in a dynamic manner in response to the first sensing signal or the second sensing signal.

18. The presentation system according to claim 17 wherein each of the first identification label and the second identification label includes a video object, an audio object or a text object.

19. The presentation system according to claim 17 wherein the video receiver device comprises a first sensing unit for sensing the first user's operating action and issuing the first sensing signal, and the video supply device comprises a second sensing unit for sensing the second user's operating action and issuing the second sensing signal.

20. The presentation system according to claim 19 wherein each of the first user's operating action and the second user's operating action is making sounds or moving a pointing device, and each of the first sensing unit and the second sensing unit is an audio sensing module or a position recording module.
